(19) United States
(12) Patent Application Publication
(10) Pub. No.: US 2024/0166828 A1
(43) Pub. Date: May 23, 2024

(54) NATURAL FIBER POLYMER COMPOSITE PRECURSOR PELLETS

(71) Applicant: Sappi Netherlands BV, Maastricht (NL)

(72) Inventors: Wim BALLET, Riemst (BE); Michaël ALEXANDRE, Ougrée (BE); Juul CUIJPERS, Herten (NL)

(21) Appl. No.: 18/329,103

(22) Filed: Jun. 5, 2023

(30) Foreign Application Priority Data
Nov. 23, 2022 (EP) EP22209201.7

(51) Int. Cl. C08J 5/04

(52) U.S. Cl. CPC C08J 5/045; C08J 2397/02; C08J 2423/12

(57) ABSTRACT

A natural fiber polymer composite precursor pellet comprising, a thermoplastic polymer coupling agent as a binder and a natural fiber, wherein the natural fiber is a bleached chemical pulp and is comprised in an amount of at least 88 weight %, and wherein the thermoplastic polymer coupling agent is comprised in an amount of between 8 and 12 weight %, preferably between 9 and 11 weight %, based on the weight of the pellet.

### RELATED APPLICATION

This application claims priority under 35 U.S.C. 119(a) from European Patent Application No. 22209201.7, filed on Nov. 23, 2022, the full disclosure of which is incorporated herein by reference.

### TECHNICAL FIELD

The present application relates to natural fiber polymer composite precursor pellets and methods of their manufacture.

### BACKGROUND

A fiber reinforced polymer composite is generally a polymer in which reinforcing fibers are dispersed throughout the bulk of the polymer. The reinforcing fibers that have been used traditionally were synthetic fibers, such as rayon or glass fiber. However, in recent developments, these synthetic fibers have been replaced by wood fibers that are considered to be less environmentally problematic.

When dispersing such wood fibers in a matrix of polymer, one of the main problems is that bulk wood fibers are lightweight and fluffy, and their incorporation into a melt of polymer can be difficult because they are hard to convey and feed into the polymer via traditional feeding systems such as hoppers or screws. While wood fibers can be compacted to pellets to enhance their ability to be conveyed and fed, another problem arises, which is that of sufficiently disintegrating and dispersing the compacted pellets in the mixing device such as a twin screw extruder.

Therefore, masterbatch-type pellets with a high wood fiber content and low polymer content have been proposed. Such masterbatch-type pellets can be easily conveyed and fed into a mixing device and also can be easily disintegrated and dispersed in the mixing device.

Such masterbatch-type pellets are generally manufactured at a central location and transported to a given site of use, where they are stored until used. Therefore, such pellets must be able to withstand the static pressure that occurs in storage silos and at the same time withstand any erosion occurring during transport.

In general, the static pressure that pellets experience in storage silos can be best dealt with by providing a hard pellet, which hardness can be quantified by a shore A hardness above a given threshold. If a pellet has a required hardness, it is generally considered as reliably suitable for storage in silos. However, erosion, being the consequence of dynamic forces during transport, is a more complex phenomenon and the suitability of pellet materials harder to predict. For instance, a high hardness of a pellet is not a reliable predictor for its propensity to erode during transport.

WO2020254713A1 discloses natural fiber plastic composite precursor materials, which may be in pellet form, which materials comprise 80 to 95% (w/w) cellulosic fibers having an average fiber length less than 1 mm, and 3 to 7% (w/w) coupling agent, and optionally a thermoplastic polymer and/or a lubricant, a wax, or both. It defines suitable pellet hardness, on page 4, i.e., not too soft and not too hard, in the range of 100-200 N, such as 120-180 N. Pellets which are too hard do not break properly during the mixing and extrusion process and resulting pellet fragments show up as little bumps in the finished product and significantly decrease its mechanical properties. Pellets which are too soft on the other hand causes powder formation and thus challenges during feeding of the material or transportation. The natural fiber plastic composite precursor materials may be formed into pellets having an average diameter in the range of 3-8 mm, such as 3-6 mm. It was also found out that pellets having an average diameter less than 3 mm were not desired, because they were prone to break or crumble during handling and/or transport.

WO2019110868A1 discloses a pulp precursor material for compounding with a polymer, the pulp precursor material comprising a dried bleached chemical pulp containing cellulose fibers, an adsorption agent on the surface of the cellulose fibers and less than 12 wt % of thermoplastic polymer compatibilizer which has been mixed with the dried bleached chemical pulp, wherein the pulp content of the pulp precursor material is equal to or higher than 80 wt. % of the pulp precursor material and the moisture content of the pulp precursor material is less than 10 wt. %. However, the use of adsorption agents is cost-intensive and constitutes one more parameter of the manufacturing process that must be controlled.

WO2017165957A1 discloses cellulosic composites including wood pulp incorporated into a polymeric matrix, where the wood pulp is a mechanical pulp comprising lignin in an amount of about 5% to 35% of the dry weight of the mechanical pulp.

### SUMMARY

The present disclosure provides a master-batch type pellet comprising a high content natural fiber that exhibits good stability and can be easily dispersed in additional polymer and yield good mechanical properties.

In one aspect, the present disclosure features a natural fiber polymer composite precursor pellet comprising from 8 to 12 weight percent of a binder comprising a thermoplastic polymer coupling agent, and at least 88 weight percent of a natural fiber comprising a bleached chemical pulp.

Some implementations may include one or more of the following features. The thermoplastic polymer coupling agent may have a melt flow index of at least 10 g/10 min., e.g., between 100 and 150 g/10 min., when measured according to ASTM D1238 at 190° C. using a weight of 1.2 kg. The thermoplastic polymer coupling agent may have a melt flow index between 120 and 200 g/10 min. when measured according to ASTM D1238 at 190° C. using a weight of 2.16 kg.

The bleached chemical pulp may be a bleached chemical wood pulp, e.g., a non-functionalized bleached chemical pulp.

The thermoplastic polymer coupling agent may be a thermoplastic polyolefin grafted with maleic anhydride and the natural fiber may be bleached sulfite wood fiber pulp or bleached kraft wood fiber pulp. The polyolefin grafted with maleic anhydride may be selected from the group consisting of maleic anhydride grafted polypropylene (PP-g-MAH) and maleic anhydride grafted polyethylene (PE-g-MAH).

The natural fiber polymer composite precursor pellet may have a Pellet Durability Index (PDI) of at least 80, as determined on a NHP200 Automated Pellet Durability Tester after 80 sec. using 100 g of cylindrical pellets having a diameter of 4 mm. The natural fiber polymer composite precursor pellet has a flock test value of between 0 and 5 as determined by the Flock test.

The pellet may comprise from 88 to 92 weight percent of the natural fiber, and/or from 9 to 11 weight percent of the binder. The natural fiber may have a length of less than 400 The pellet may have a bulk density of more than 600 g/dm3.

In another aspect, the disclosure features a method comprising the steps of: (a) combining a natural fiber comprising a bleached chemical wood fiber pulp, in an amount of at least 88 weight percent, with a binder comprising a thermoplastic polymer coupling agent, in an amount of between 8 and 12 weight percent, in a thermokinetic mixer to form a natural fiber polymer composite precursor, and (b) compacting the natural fiber polymer composite precursor in a non-molten state in a pellet mill to form a natural fiber polymer composite precursor pellet.

Some implementations of this method may include one or more of the following features. The method may further include (i) combining the natural fiber polymer composite precursor pellet with a thermoplastic polymer in a twin screw extruder (TSE) having a L/D ratio of more than 32:1 at a temperature of less than 200° C. to form a natural fiber polymer composite melt, and (ii) solidifying the natural fiber polymer composite melt to obtain a natural fiber polymer composite.

The thermoplastic polymer may comprise a polypropylene having a melt flow index of at least 2 when measured according to ASTM D1238 at 230° C. using a weight of 2.16 kg.

The twin screw extruder may be equipped with at least one vacuum vent.

The Specific Mechanical Energy (SME) imparted on the natural fiber polymer composite melt may be between 0.15 and 0.20 kW/kg·h.

In a further aspect, the disclosure features a method comprising: (a) providing a plurality of natural fiber composite precursor pellets, the pellets comprising from 8 to 12 weight percent of a binder comprising a thermoplastic polymer coupling agent; and at least 88 weight percent of a natural fiber comprising a bleached chemical pulp; (b) disintegrating and dispersing the pellets in a mixing device to form a polymeric mixture; and (c) using the polymeric mixture in a molding process to form an automotive interior part.

The disclosure also features automotive interior parts, such as an instrument panel, a door panel, a ceiling panel, a glove box, or a control button, formed by molding the pellets disclosed herein, for example using the method described above.

Within this specification embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

### DETAILED DESCRIPTION

The present disclosure features a natural fiber polymer composite precursor pellet comprising a thermoplastic polymer coupling agent as a binder and a natural fiber, wherein the natural fiber is a bleached chemical pulp and is present in an amount of at least 88 weight %, and wherein the thermoplastic polymer coupling agent is present in an amount of between 8 and 12 weight %, and preferably between 9 and 11 weight %, based on the weight of the pellet.

In some embodiments, the natural fiber polymer composite precursor pellet consists essentially of or consists of the thermoplastic polymer coupling agent as a binder and the natural fiber. In some cases, the natural fiber polymer composite precursor pellet of the present invention consists solely of bleached chemical pulp and thermoplastic polymer coupling agent, and other components such as waxes or lubricants are not present.

The omission of waxes and lubricants allows a natural fiber polymer composite to be obtained, based on the natural fiber polymer composite precursor pellet, that can be used in automobile manufacturing, in particular in interior panels, because the presence of the natural fiber polymer composite in the vehicle does not lead to fogging. Fogging refers to depositions on the inner side of the windscreen or other windows in a car, which are caused by the VOC emissions emanating from polymer parts in the car interior that evaporate and condense on the window surfaces. Waxes and lubricants are known to lead to fogging.

Further, in implementations in which the pellet does not include components other than the bleached chemical pulp and the thermoplastic polymer coupling agent allows a natural fiber polymer composite to be obtained, based on the natural fiber polymer composite precursor, that has no discernable odor, as no odorous components are released from either thermoplastic polymer coupling agents or bleached chemical pulp. In addition, the use of bleached chemical pulp further reduces the development of odor and/or discoloration due to the removal of lignin via chemical pulping and bleaching. The above advantages of the natural fiber polymer composite precursor pellet allow a natural fiber polymer composite to be obtained that can be used without having to worry about odor, color, transport or dispersion.

The natural fiber polymer composite precursor pellet may, for example, be a pellet having a spherical, cylindrical, or lenticular shape, and preferably has a cylindrical shape. The pellets of the present invention can be easily metered into a mixing device such as a twin screw extruder via a suitable feeder device such as for example a gravimetric hopper. The pellets may have a diameter of between 2 and 6 mm.

In implementations in which the natural fiber polymer composite precursor pellet has a cylindrical shape, the cylinder may have a length of between 5 and 20 mm, preferably between 5 and 10 mm, and/or may have a diameter of between 2 and 6 mm, and preferably of between 3 and 4 mm, such as for example 3 mm. When the cylindrical shape has the aforementioned dimensions, the pellet may exhibit several advantageous properties, such as excellent resistance against erosion during transport and excellent dispersion when incorporated into further polymer during the production of a natural fiber polymer composite.

In implementations in which the natural fiber polymer composite precursor pellet has a spherical or lenticular shape the pellet may have a diameter of between 2 and 6 mm.

The natural fiber polymer composite precursor pellet may be obtained, for example, by passing a natural fiber polymer composite precursor in a pelletizing device such as pellet mill equipped with a flat die or a ring die, and preferably in a pellet mill equipped with a flat die. For instance, a ring pelletizer may provide pellets having a cylindrical shape and a diameter of 3, 4, or 6 mm and a flat die pelletizer may provide pellets having a cylindrical shape and a diameter of 3 or 4 mm. It is noted that the natural fiber polymer composite precursor has the same composition of the natural fiber polymer composite precursor pellets. It has been observed that pellets of cylindrical shape and a diameter of 3 or 4 mm, especially when obtained on a flat die pellet mill, lead to easy dispersion when producing a natural fiber polymer composite.

The natural fiber polymer composite precursor pellet comprises a thermoplastic polymer coupling agent as a binder and a natural fiber. Even though the thermoplastic polymer coupling agent, at least in terms of weight, forms the smaller part of the natural fiber polymer composite precursor pellet, it effectively forms a binding component in which the natural fiber is bound.

In some implementations the bleached chemical pulp is present in an amount of at least 88 weight %, or in an amount of between 88 and 92 weight %, based on the weight of the natural fiber polymer composite precursor pellet. In some implementations the bleached chemical pulp is present in an amount of from about 88 and 90 weight % or between 89 and 91 weight %. It has been found that when the content of the bleached chemical pulp within the natural fiber polymer composite precursor pellet is within the above ranges, the amount of bleached chemical pulp can be maximized without compromising the resistance against erosion during transport and the quality of dispersion when incorporated into further polymer during the production of a natural fiber polymer composite. Bleached chemical pulp, when at equilibrium with normal atmospheric humidity, tends to absorb humidity in amounts of up to 8 weight %. Thus, when combining the bleached chemical pulp, the amount of humidity in the bleached chemical pulp is to be measured and taken into account when weighing the bleached chemical pulp such that in the natural fiber polymer composite precursor pellet, the final amount of bleached chemical pulp corresponds to the intended amount within the natural fiber polymer composite precursor pellet.

Suitable bleached chemical pulps include bleached chemical pulp obtained via various chemical pulping processes such as the Kraft process (Kraft pulp), the sulfite process (sulfite pulp) or soda pulping. Thus, the bleached chemical pulp may be a bleached sulfite pulp such as paper pulp or dissolving pulp, a bleached kraft pulp such as Northern bleached softwood or hardwood kraft or Southern bleached softwood or hardwood kraft and the like. Bleaching a chemical pulp removes further lignin to yield a pulp having usually less than 5% and often less than 1% by weight of lignin, based on the weight of the bleached chemical pulp. Thus, in the natural fiber polymer composite precursor pellet of the present invention, the chemical pulp bleached chemical pulp has less than 5%, preferably less than 3% and more preferably less than 2% by weight of lignin, based on the weight of the bleached chemical pulp.

The bleached chemical pulp may be a bleached chemical wood pulp, i.e., a pulp sourced from hardwoods and softwoods. It is noted that the wood pulp may be hardwood pulp only, softwood pulp only or a mixture of hardwood and softwood pulp.

The bleached chemical pulp may have a length of less than 400 μm, preferably of less than 200 μm or more preferably of less than 50 μm. In a preferred embodiment, the bleached chemical pulp is knife-milled to a length of less than 200 μm. When the length of the bleached chemical pulp is less than 400 μm, and in particular when the length of the bleached chemical pulp less than 200 μm, the tendency to form flocks that cannot be dispersed is significantly reduced in the natural fiber polymer composite precursor pellets. Thus, when the length of the bleached chemical pulp less than 400 μm, and in particular when the length of the bleached chemical pulp less than 200 μm, it is not necessary to promote dispersion of the bleached chemical pulp using suitable agents, such as for example adsorption agents. It is understood that in the above context, “a natural fiber having a length of less than X μm” means a natural fiber in which at least 90% and preferably at least 95% of the fibers have a length of X μm or less.

In some implementations the pellet has a bulk density of more than 600 g/dm³.

In some embodiments, the bleached chemical pulp is a non-functionalized bleached chemical pulp, i.e., as obtained from the final bleaching process, or “as-is”, i.e., without any further chemical functionalization of the bleached chemical pulp or addition of adsorption agents, such as for example silanization. It has been found that functionalizing the bleached chemical pulp, such as for example with aminosilanes, is not necessary in order to obtain a natural fiber polymer composite precursor pellet that is easily dispersed, when incorporated into further polymer during the production of a natural fiber polymer composite.

The natural fiber polymer composite precursor pellet may include, in some implementations, a thermoplastic polymer coupling agent in an amount of between 8 and 12 weight %, preferably between 8 and 10 weight % or between 9 and 11 weight %, based on the weight of the natural fiber polymer composite precursor pellet. It has been found that when the content of the thermoplastic polymer coupling agent within the natural fiber polymer composite precursor pellet is within the above ranges, the amount of thermoplastic polymer coupling agent can be maximized without compromising on the resistance against erosion during transport and the quality of dispersion when incorporated into further polymer during the production of a natural fiber polymer composite.

The thermoplastic polymer coupling agent may be, for example, a thermoplastic polyolefin grafted with an acid anhydride, preferably a thermoplastic polyolefin grafted with a maleic anhydride such as for example maleic anhydride grafted polypropylene (PP-g-MAH) or maleic anhydride grafted polyethylene (PE-g-MAH).

The thermoplastic polymer coupling agent may have a weight average molecular weight of between 80,000 and 85,000 g/mol, when measured by high temperature gel permeation chromatography in 1,2,4 trichlorobenzene at 140° C., using polystyrene standards for calibration.

The thermoplastic polymer coupling agent may have a melt flow index of at least 10 g/10 min., preferably between 100 and 150 g/10 min., and more preferably between 105 and 130 g/10 min., when measured according to ASTM D1238 at 190° C. using a weight of 1.2 kg.

In some implementations, the thermoplastic polymer coupling agent has a melt flow index of at least 10 g/10 min., preferably of between 120 and 200 g/10 min., and more preferably between 140 and 180 g/10 min., when measured according to ASTM D1238 at 190° C. using a weight of 2.16 kg.

In some implementations, the natural fiber polymer composite precursor pellet has a Pellet Durability Index (PDI) of more than 80, preferably of between 85 and 95, more preferably of between 90 and 95 as determined on a NHP200 Automated Pellet Durability Tester after 80 s, using 100 g of cylindrical pellets and having a diameter of 4 mm.

In some implementations, the natural fiber polymer composite precursor pellet has a flock test value of between 0 and 5 as determined by the flock test. A flock is in principle visible to the naked eye, and is a non-dispersible aggregate of natural fiber in the natural fiber polymer composite precursor pellet, and it is desirable to keep the number of flocks to a minimum. A flock can however not be discerned in the natural fiber polymer composite precursor pellet because of the overall content of natural fiber in the natural fiber polymer composite precursor pellet, and so it must be determined via an appropriate test. The flock test is designed to determine the amount of aggregates found in the natural fiber polymer composite precursor pellet by diluting natural fiber polymer composite precursor pellet in a thermoplastic polymer such as a thermoplastic polyolefin via melt blending and into test pellets, such that the final concentration of natural fiber in the test pellets is 40 weight percent, based on the weight of the test pellet. A given amount of test pellets, which may have a cylindrical shape and a diameter of 2 to 6 mm such as for example 3 mm or 4 mm, is then introduced into a hot press operating at a temperature that is at least the melting temperature of the thermoplastic polymer and flattened to a roughly circular piece of about 15 mm of diameter. Then, any flocks are determined by visual inspection, without magnification, and the number of flocks is determined, giving the flock test value.

The assumption in the flock test is that flocks that were present in the natural fiber polymer composite precursor pellet of the present invention cannot be dispersed when melt blended with the further thermoplastic polymer, and that therefore any flocks that are detected correspond to flocks in the natural fiber polymer composite precursor pellet of the present invention. It is understood that when the thermoplastic polymer coupling agent is based on a given thermoplastic polymer, the thermoplastic polymer used in the melt blending to obtain the test pellets is the same. For instance, if the thermoplastic polymer coupling agent is maleic anhydride polypropylene, then the thermoplastic polymer for obtaining test pellets is a polypropylene, and if the thermoplastic polymer coupling agent is maleic anhydride polyethylene, then the thermoplastic polymer for obtaining test pellets is a polyethylene. In particular, when the thermoplastic polymer coupling agent and the thermoplastic polymer for dilution are polypropylene or a polyethylene, the thermoplastic polymer preferably has a melt flow index of at least 2, or between 20 and 100 when measured according to ASTM D1238 at 230° C. using a weight of 2.16 kg.

The natural fiber polymer composite precursor pellets disclosed herein may be used in many types of natural fiber polymer composites. Such a natural fiber polymer composite may be in the form of an automotive part, in particular an automotive interior part such as an instrument panel, a door panel, a ceiling panel, a glove box, or a control button.

As discussed above, the present disclosure also features a method of producing a natural fiber polymer composite precursor pellet, comprising the steps of (a) combining a natural fiber, in an amount of at least 88 weight %, with a thermoplastic polymer coupling agent, in an amount of between 8 and 12 weight %, based on the weight of the pellet, in a thermokinetic mixer such as a hot/cold mixer to form an natural fiber polymer composite precursor, wherein the thermoplastic polymer coupling agent forms the binder and the natural fiber is a bleached chemical wood fiber pulp, and (b) compacting the natural fiber polymer composite precursor pellet in a non-molten state in a pellet mill to form a natural fiber polymer composite precursor pellet.

In an embodiment of the method of producing a natural fiber polymer composite precursor pellet, the natural fiber alone, such as the bleached chemical pulp, may be agitated in the thermokinetic mixer, for example a hot/cold mixer, to reduce the moisture content of the bleached chemical pulp to a moisture of less than 1 weight %, or less than 0.5 weight % in a separate step, prior to step (a), i.e., prior to the contact with the thermoplastic polymer coupling agent.

In an embodiment of the method of producing a natural fiber polymer composite precursor pellet, the pellet may have a length of between 5 and 20 mm or between 5 and 10 mm, and/or a diameter of between 2 and 6 mm. The pellet may preferably have a cylindrical shape.

The disclosure also features a method of producing a natural fiber polymer composite, comprising the steps of combining the natural fiber polymer composite precursor pellet with an amount of a thermoplastic polymer, such as a polyolefin, in a twin screw extruder (TSE) having a L/D ratio of more than 32:1 at a temperature of less than 200° C. and preferably of less than 180° C., to form a natural fiber polymer composite melt and solidifying said natural fiber polymer composite melt to obtain a natural fiber polymer composite.

In some embodiments of the method of producing a natural fiber polymer composite, the thermoplastic polymer is a polyolefin, in particular a polypropylene, having a melt flow index of at least 2, or between 20 and 100 when measured according to ASTM D1238 at 230° C. using a weight of 2.16 kg.

The amount of thermoplastic polymer may be chosen so that the amount of natural fiber in the natural fiber polymer composite is between 10 weight % to 60 weight %, preferably between 20 weight % to 40 weight %, based on the weight of the natural fiber polymer composite.

In some implementations the TSE is equipped with at least one vacuum vent and/or the Specific Mechanical Energy (SME) imparted on the natural fiber polymer composite melt is between 0.15-0.20 kW/kg·h.

The methods disclosed herein may further include forming the natural fiber polymer composite into an automotive part in a subsequent step, in particular an automotive interior part such as an instrument panel, a door panel, a ceiling panel, a glove box, or a control button.

### OTHER EMBODIMENTS

A number of embodiments have been described. Nevertheless, it will be understood that various modifications may be made without departing from the spirit and scope of the disclosure.

Accordingly, other embodiments are within the scope of the following claims.

1. A natural fiber polymer composite precursor pellet comprising:
from 8 to 12 weight percent of a binder comprising a thermoplastic polymer coupling agent; and
at least 88 weight percent of a natural fiber comprising a bleached chemical pulp, wherein the thermoplastic polymer coupling agent has a melt flow index of at least 10 g/10 min. when measured according to ASTM D1238 at 190° C. using a weight of 1.2 kg.

2. (canceled)

3. The natural fiber polymer composite precursor pellet of claim 1, wherein the thermoplastic polymer coupling agent has a melt flow index between 100 and 150 g/10 min. when measured according to ASTM D1238 at 190° C. using a weight of 1.2 kg.

4. The natural fiber polymer composite precursor pellet of claim 1, wherein the thermoplastic polymer coupling agent has a melt flow index between 120 and 200 g/10 min. when measured according to ASTM D1238 at 190° C. using a weight of 2.16 kg.

5. The natural fiber polymer composite precursor pellet of claim 1 wherein the bleached chemical pulp is bleached chemical wood pulp.

6. The natural fiber polymer composite precursor pellet of claim 5 wherein the bleached chemical wood pulp is a non-functionalized bleached chemical pulp.

7. The natural fiber polymer composite precursor pellet according to claim 1, wherein the thermoplastic polymer coupling agent is a thermoplastic polyolefin grafted with maleic anhydride and the natural fiber is bleached sulfite wood fiber pulp or bleached kraft wood fiber pulp.

8. The natural fiber polymer composite precursor pellet of claim 7, wherein the polyolefin grafted with maleic anhydride is selected from the group consisting of maleic anhydride grafted polypropylene (PP-g-MAH) and maleic anhydride grafted polyethylene (PE-g-MAH).

9. The natural fiber polymer composite precursor pellet according to claim 1, wherein the natural fiber polymer composite precursor pellet has a Pellet Durability Index (PDI) of at least 80, as determined on a NHP200 Automated Pellet Durability Tester after 80 sec. using 100 g of cylindrical pellets having a diameter of 4 mm.

10. The natural fiber polymer composite precursor pellet according to claim 1, wherein the natural fiber polymer composite precursor pellet has a flock test value of between 0 and 5 as determined by the Flock test.

11. The natural fiber polymer composite precursor pellet of claim 1, wherein the pellet comprises from 88 to 92 weight percent of the natural fiber.

12. The natural fiber polymer composite of claim 11, wherein the pellet comprises from 9 to 11 weight percent of the binder.

13. The natural fiber polymer composite precursor pellet according to claim 1, wherein the natural fiber has a length of less than 400 μm.

14. The natural fiber polymer composite precursor pellet according to claim 1, wherein the pellet has a bulk density of more than 600 g/dm³.

15. A method comprising the steps of:
(a) combining a natural fiber comprising a bleached chemical wood fiber pulp, in an amount of at least 88 weight percent, with a binder comprising a thermoplastic polymer coupling agent, in an amount of between 8 and 12 weight percent, in a thermokinetic mixer to form a natural fiber polymer composite precursor, and
(b) compacting the natural fiber polymer composite precursor in a non-molten state in a pellet mill to form a natural fiber polymer composite precursor pellet,
wherein the thermoplastic polymer coupling agent has a melt flow index of at least 10 g/10 min. when measured according to ASTM D1238 at 190° C. using a weight of 1.2 kg.

16. The method of claim 15, further comprising (a) combining the natural fiber polymer composite precursor pellet with a thermoplastic polymer in a twin screw extruder (TSE) having a L/D ratio of more than 32:1 at a temperature of less than 200° C. to form a natural fiber polymer composite melt, and (b) solidifying the natural fiber polymer composite melt to obtain a natural fiber polymer composite.

17. The method of claim 16, wherein the thermoplastic polymer comprises a polypropylene having a melt flow index of at least 2 when measured according to ASTM D1238 at 230° C. using a weight of 2.16 kg.

18. The method of claim 16, wherein the twin screw extruder is equipped with at least one vacuum vent.

19. The method of claim 18, wherein the Specific Mechanical Energy (SME) imparted on the natural fiber polymer composite melt is between 0.15 and 0.20 kW/kg·h.

20. A method comprising:
(a) providing a plurality of natural fiber composite precursor pellets, the pellets comprising from 8 to 12 weight percent of a binder comprising a thermoplastic polymer coupling agent; and at least 88 weight percent of a natural fiber comprising a bleached chemical pulp;
(b) disintegrating and dispersing the pellets in a mixing device to form a polymeric mixture; and
(c) using the polymeric mixture in a molding process to form an automotive interior part,
wherein the thermoplastic polymer coupling agent has a melt flow index of at least 10 g/10 min. when measured according to ASTM D1238 at 190° C. using a weight of 1.2 kg.
